(19) United States
(12) Patent Application Publication
(10) Pub. No.: US 2014/0295237 A1
(43) Pub. Date: Oct. 2, 2014

(54) ELECTROCHEMICAL CELLS USEFUL FOR ENERGY STORAGE DEVICES

(71) Applicant: General Electric Company, Schenectady, NY (US)

(72) Inventors: Sundeep Kumar, Bangalore (IN); Alireza Pezhman Shirvanian, Guilderland, NY (US)

(73) Assignee: General Electric Company, Schenectady, NY (US)

(21) Appl. No.: 14/210,675

(22) Filed: Mar. 14, 2014

Related U.S. Application Data
(63) Continuation-in-part of application No. 13/852,462, filed on Mar. 28, 2013.

(51) Int. Cl. H01M 10/39

(52) U.S. Cl. CPC H01M 10/399
USPC 429/104

(57) ABSTRACT

An energy storage cell is disclosed, including an anodic chamber for containing an anodic material and a cathodic chamber for containing a cathodic material, separated from each other by an electrolyte separator tube, and all contained within a case for the cell. The cell further includes a ceramic collar positioned at an opening of the cathodic chamber, defining an aperture in communication with the opening, and a current collector brazed to the ceramic collar, extending into the cathodic chamber. The current collector is in the form of a porous, metallic mesh, and the case and the ceramic collar are hermetically sealed to each other by an active braze material. Sodium metal halide batteries based on a number of these cells are also disclosed.

This Patent Application is a Continuation-in-Part of application Ser. No. 13/852,462, filed on Mar. 28, 2013, the contents of which are incorporated herein by reference.

### TECHNICAL FIELD

This invention generally relates to electrochemical devices, such as batteries. In some particular embodiments, the invention relates to sealing systems and current-carrying features within various energy storage devices.

### BACKGROUND OF THE INVENTION

Metal chloride batteries, especially sodium-metal chloride batteries with a molten sodium negative electrode (usually referred to as the anode) and a beta-alumina solid electrolyte, are of considerable interest for energy storage applications. In addition to the anode, the batteries include a positive electrode (usually referred to as the cathode) that supplies/receives electrons during the charge/discharge of the battery. The solid electrolyte, described below, functions as the membrane or “separator” between the anode and the cathode.

The metal chloride batteries and other types of thermal batteries can be employed in a number of applications, such as uninterruptable power supply (UPS) devices; or as part of a battery backup system for a telecommunications (“telecom”) device, sometimes referred to as a telecommunication battery backup system (TBS). The batteries are often capable of providing power surges (high currents) during the discharge cycle. In an ideal situation, the battery power can be achieved without a significant loss in the working capacity and the cycle life of the battery. The advantageous features of these types of batteries provide opportunities for applications in a number of other end use areas as well.

FIG. 1 is a simple illustration of an energy storage cell 10. The cell includes a housing 12. The housing includes a separator 14, having an outer surface 16, and an inner surface 18. The outer surface defines a first chamber 20 and the inner surface defines a second chamber 22 The first chamber is usually an anode including sodium, and the second chamber is a usually a cathode that can include a number of salts. The first chamber is in ionic communication with the second chamber through the separator. The first chamber and the second chamber further include an anode current collector 24 and a cathode current collector 26 to collect the current produced by the electrochemical cell. Other details regarding such a cell are provided, for example, in U.S. Pat. No. 7,632,604 (Iacovangelo et al).

The current collectors are important elements in the operation of these types of electrochemical cells, since they are directly responsible for electrical conductivity characteristics. In particular, the cathode current collector can be an especially important element in a sodium-metal chloride battery. In part, this is because of the belief that the cathode electrochemical reactions are not only concentrated spatially, but include both a spatial and a temporal distribution during the charge/discharge cycles of the cells. Therefore, in order to facilitate the electrochemical reactions that must occur in the cell, it is important for the current collector to provide electronic conductivity to the “reaction front”, with such a distribution characteristic.

Electrochemical cells of this type (such as batteries) operate at high temperatures, usually above about 250 degrees Celsius (° C.); and they include a number of components that need to be sealed (e.g., hermetically sealed), to ensure that each battery cell will function properly. The sodium metal halide (NaMx) batteries, for instance, may contain electrochemical cells that include a sodium metal anode and a metal halide (NiCl₂ for example) cathode. A beta”-alumina solid electrolyte (BASE) separator can be used to separate the anode and cathode. The solid electrolyte may allow the transport of sodium ions between anode and cathode. A secondary electrolyte (NaAlCl₄) can also be used in the cathode mixture. The cathode mixture typically contains nickel and sodium chloride, along with other additives. The cathode mixture is contained inside the BASE tube, which is closed or sealed on one end after filling. At operating temperatures, the cathode mixture may be in a molten fluid or fluid-like form.

In present, typical designs of NaMx and sodium sulfur cells, the open end of the beta”-alumina ceramic tube is joined to an alpha-alumina collar using a glass seal. Spinel, zirconia, yttria, or other ceramic insulators, or combinations thereof, may also be used as a collar material in NaMx cells. The alpha-alumina collar electrically isolates the anode from the cathode. In order to enable the sealing of this ceramic subassembly to the current collectors (anode and cathode), and thereby at least partially seal the cell, two metallic rings (typically Ni) are typically coupled or bonded to the alpha-alumina collar prior to the sealing glass operation. The inside Ni ring is then typically welded to a cathode current collector assembly, and the current collector assembly includes another weld. The outside Ni ring is typically welded to an anode current collector (e.g., the metallic battery case) via a metal (e.g., Ni) outer bridge member.

Moreover, the various sealing mechanisms within the cell are all critical for its function, reliability, and safety. For example, the integrity (e.g., strength and/or hermeticity) of the glass seal joint between the beta”-alumina ceramic tube and the alpha-alumina collar is very important to the overall integrity of the cell. The same holds true for other joining regions, e.g., the weld between the inside metal ring and the cathode current collector; the weld within the cathode current collector assembly; and the welds between the bridge member and the outer metal ring and the anode current collector, e.g., the battery case. The strength of metal-ceramic joints between the outer and inner metal rings and the ceramic collar can also be critical. As a result, each joint or seal must be formed under specific conditions and process steps particular to the specific type of seal (weld, glass seal, metallization/thermal compression bonding (TCB), etc.) being used to ensure hermeticity.

patent application Ser. No. 13/852,462 (S. Kumar et al, referenced above), provides a description of battery cells with these types of sealing mechanisms used in the prior art, for the sealing of an anodic chamber, as well as other cell structures. Illustrative FIGS. 1 and 2 in the Kumar Application describe a cell that includes an outer metal ring hermetically sealed to a ceramic collar, by way of a metallization/TCB process. A bridge member, often made of nickel, is electrically coupled and hermetically sealed to the outer ring of the cell's metal case. As described in the Kumar Application, a number of welds are usually required to attach the bridge member to the surrounding structures.

Welds and other types of joints and seals in these types of high-temperature electrochemical cells very often represent points of weakness and potential failure. As an illustration, noted in the Kumar patent application, the joints between electrochemical cell bridge members, ring structures, and cell cases are often formed as lap or edge welds. It is known that these types of welds can be relatively difficult to manufacture, and are prone to relatively high failure rates. The welds and joints therefore need to be subjected to numerous inspections and tests to ensure their reliability. This can represent a manufacturing and operational disadvantage—even more so when there are a relatively large number of joints, since they represent a large number of potential failure points.

With these considerations in mind, new types of energy storage devices and other types of electrochemical cells would be welcome in the art. The new devices should exhibit improved electrical conductivity, e.g., by way of unique features within the various cell compartments. Moreover, the devices should be obtainable with lower fabrication costs, and higher reliability, e.g., by reducing the number of sealing mechanisms within the devices.

### BRIEF DESCRIPTION

One embodiment of the invention is directed to an energy storage cell, comprising:

(a) an anodic chamber for containing an anodic material; and a cathodic chamber for containing a cathodic material, separated from each other by an electrolyte separator tube, all contained within a case for the cell;

(b) an electrically insulating ceramic collar positioned at an opening of the cathodic chamber, and defining an aperture in communication with the opening; and

(c) a current collector brazed to the ceramic collar, extending into the cathodic chamber, and in the form of a porous, metallic mesh. In preferred embodiments, the case and the ceramic collar are hermetically sealed to each other by at least one active braze.

Another embodiment of the invention relates to a sodium metal halide thermal battery, comprising a plurality of electrochemical cells that are in electrical communication with each other, wherein each electrochemical cell comprises:

(a) an anodic chamber for containing an anodic material; and a cathodic chamber for containing a cathodic material, separated from each other by an electrolyte separator tube, all contained within a case for the cell;

(b) an electrically insulating ceramic collar positioned at an opening of the cathodic chamber, and defining an aperture in communication with the opening; and

(c) a current collector brazed to the ceramic collar, extending into the cathodic chamber, and in the form of a porous, metallic mesh; and wherein the case and the ceramic collar are hermetically sealed to each other by at least one active braze.

### BRIEF DESCRIPTION OF THE DRAWINGS

FIG. 1 is a schematic of an energy storage cell.

FIG. 2 is a cross-sectional schematic of a portion of an energy storage cell of the prior art.

FIG. 3 is a cross-sectional view of an energy storage cell according to embodiments of the present invention.

FIG. 4 is a sectional view of a portion of the storage cell of FIG. 3, taken through plane 4-4.

FIG. 5 is a cross-sectional view of an energy storage cell according to other embodiments of the present invention.

FIG. 6 is a top view of the storage cell of FIG. 5, taken through plane 6-6.

FIG. 7 is a cross-sectional view of an energy storage cell according to other embodiments of the present invention.

FIG. 8 is a sectional view of the storage cell of FIG. 7, taken through plane 8-8.

FIG. 9 is a top view of portions of the storage cell of FIG. 7, taken through plane 9-9.

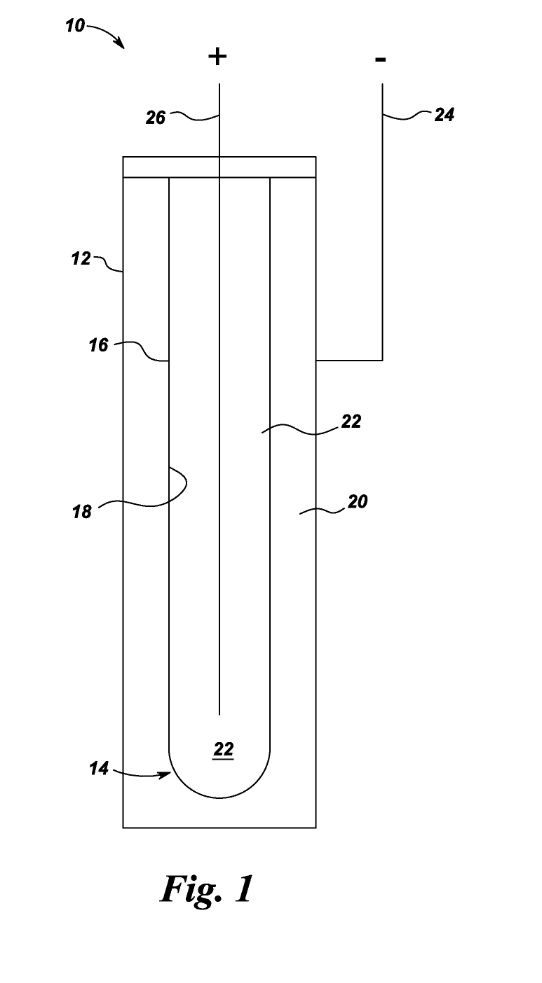

### DETAILED DESCRIPTION OF THE INVENTION

Each embodiment presented below facilitates the explanation of certain aspects of the invention, and should not be interpreted as limiting the scope of the invention. Moreover, approximating language, as used herein throughout the specification and claims, may be applied to modify any quantitative representation that could permissibly vary, without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

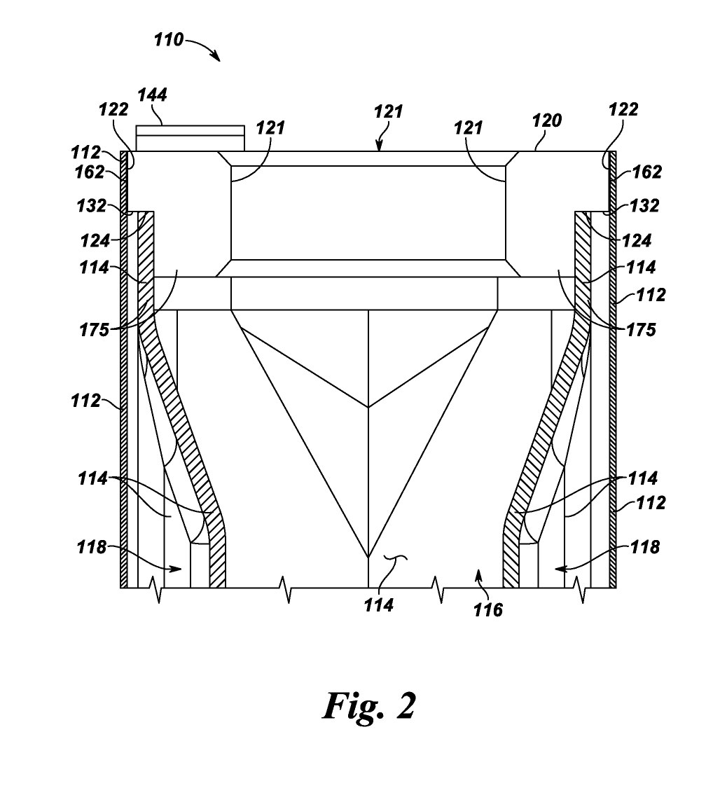

As alluded to previously, one aspect of the present invention relates to energy storage devices that include sealing systems in which device components can be hermetically sealed to each other by at least one active braze. Moreover, preferred embodiments eliminate the need for bridge members, or for a relatively large number of weld-sites. FIG. 2 provides a description of some of these embodiments, although all of the features of the present invention are not included in this figure (thus deemed “prior art”).

The general depiction of FIG. 2 is also described in the above-referenced Ser. No. 13/852,462, and depicts a sodium-based battery cell, e.g., of the sodium metal halide- or sodium-sulfur type. Many details regarding some of these types of devices are provided, for example, in U.S. patent application Ser. Nos. 13/407,870, filed Feb. 29, 2012; 13/538,203, filed Jun. 29, 2012; 13/600,333, filed Aug. 31, 2012; 13/628,548, filed Sep. 27, 2012; 13/483,841, filed May 30, 2012; and 13/595,541 filed Aug. 27, 2012, all of which are expressly incorporated herein by reference, in their entirety.

In FIG. 2, cell 110 includes electrically conductive case 112 (i.e., the anode current collector), an electrolyte separator tube 114, cathodic chamber 116, and anodic chamber 118. A ceramic collar 120, often formed substantially of alpha-alumina, is usually proximate to the opening of the separator tube. For example, the collar can be seated at the upper opening of the cathode chamber, which is defined, at least partially, by the interior of the separator tube 114. (The anodic chamber can be said to be defined by the case, the ceramic collar, and the separator tube).

In many embodiments, the outer-facing sealing surface 122 of the collar 120 may be substantially planar, and may extend about the periphery of the collar 120. In this manner, the sealing surface may be utilized to seal the periphery of the collar 120 to the case 112. More specifically, as shown in FIG. 2, the outer-facing sealing surface 122 extends about the exterior periphery of the collar 120 and is sealed (e.g., hermetically sealed) to the case 112 via one or more active braze layers (e.g., material 162) that extend about the periphery of the collar 120. Internal aperture 121, which is in communication with the interior of the separator tube 114, can be sealed (e.g., hermetically sealed). The active braze 162, sealing the insulating collar 120 and the conductive case 112, can usually be disposed on any corner, lap, edge or butt joint present in the cell.

With continued reference to FIG. 2, the electrically insulating ceramic collar 120 may include or define a rim or extended surface or portion 124 that extends out past the exterior of the separator tube 114, about the periphery of the collar 120. The separator tube 114 may be proximate or adjacent to the rim 124. For example, the separator tube 114 may extend from the ceramic collar 120 at the location or portion of rim 124. In the illustrative embodiment of FIG. 2, the collar 120 is “T” shaped, such that the exterior surface of the upper cross-member or portion of the “T” shape defines the sealing surface 122 of the collar 120, and the bottom or underside surface or portion of the upper cross-member or portion of the “T” shape defines the rim 124.

As also shown in FIG. 2, the other leg, member or portion of the “T” shape (i.e., in addition to the upper cross-member or portion) may extend into the cathodic chamber 116. In this way, the rim 124 may extend to the sealing surface 122 a distance or thickness that is greater than the corresponding distance or thickness of the wall of the separator tube 114, such that a gap or space between the exterior surface of the separator tube 114 and the interior surface of the case 112 is formed. Stated differently, the collar 120 may be configured (e.g., the configuration of the sealing surface 122 and rim 124) such that when the sealing surface 122 and the case 112 are hermetically sealed to one another (e.g., via one or more active braze deposits), the anodic chamber 118 may be hermetically sealed and formed between the case 112, collar 120 and separator tube 114.

With continued reference to FIG. 2, the cell 110 may include a first terminal member or portion 144 (i.e., an anode terminal) that may be electrically coupled, either directly or indirectly, to the electrically conductive case 112 (i.e., the anode current collector). For example, the first terminal 144 may be welded to the case 112 of a portion of the case 112. The first terminal 144 may be configured to facilitate the connection of an electrical lead that can be utilized to run the cell 110 and/or draw electrical current therefrom during use (so as to enable, at least partially, for the transport of sodium ions between the anode and the cathode of the cell 110). For example, the first terminal 144 may be the negatively charged terminal of the cell 110. In some embodiments, the first terminal may be used in conjunction with a second terminal member or portion (i.e., a cathode terminal) utilized to run the cell 110 and/or draw electrical current therefrom during use, e.g., for the transport of sodium ions between anode and cathode of the cell.

It should be understood that an electrochemical cell like that depicted in FIG. 2 can include the specialized current collectors for embodiments of the present invention, as discussed below. These cells do not require the presence of bridge elements or a relatively large number of weld sites. As alluded to previously, the braze-based design can be easier to fabricate, and can be more reliable, with less points of potential seal-failure.

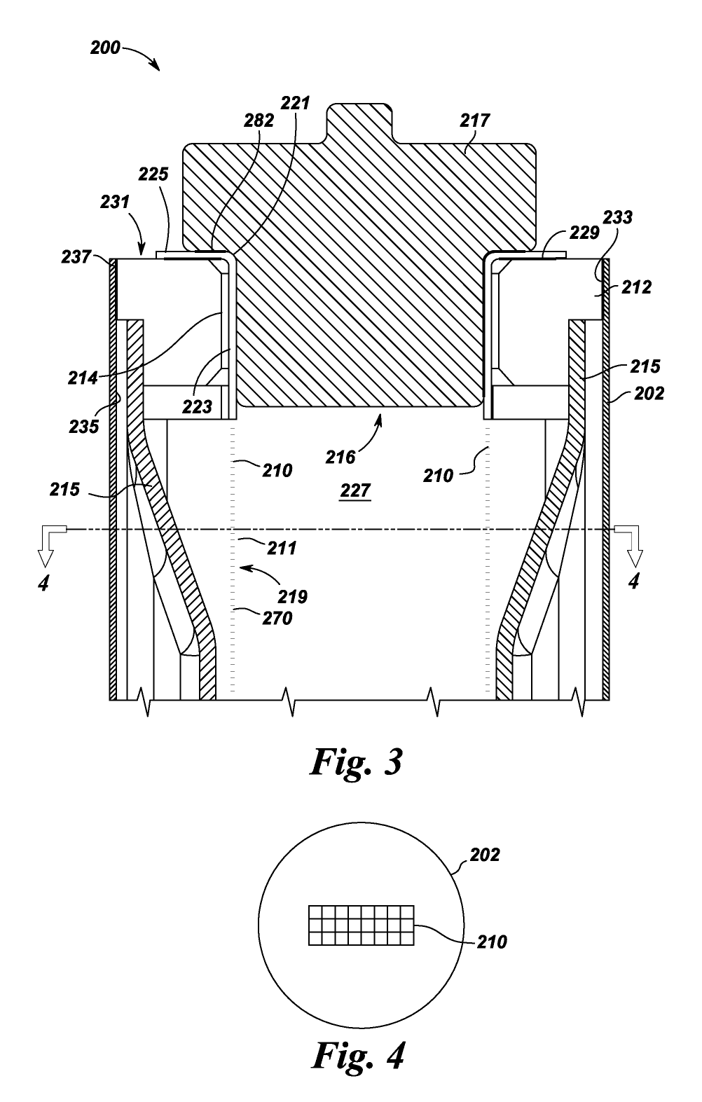

FIG. 3 depicts an embodiment of an electrochemical cell that is particularly preferred for the present invention. The general design and shape for the internal compartments of the cell are similar to that of the embodiment set forth in FIG. 4 of patent application Ser. No.. 13/852,462. This embodiment can include a cathode current collector that has an interior aperture that is considerably larger than many of the analogous apertures of the prior art.

Cell 200 in FIG. 3 includes a cathode current collector 210 sealed to the ceramic collar 212 of a unitary component 214 that includes the collar and the separator tube 215, all contained within cell case 202. As described previously, the separator tube is preferably formed of beta”-alumina (beta double prime alumina). The current collector 210 is positioned within the interior aperture 216 of the cathode chamber 227, and defines a tube or tube-like structure that includes an annular lip or flange at one end that is sealed (e.g., hermetically sealed) to an upper surface or portion of the collar 212. Cap member 217 is configured to substantially seal the interior aperture of the current collector 210.

The cathode current collector 210 includes or defines an internal aperture that may be concentric with the internal aperture 216 of the cathode chamber, when the collar and the cathode current collector are sealed to one another, as shown in FIG. 3. The flange of the cathode current collector and the upper surface or portion of the collar 212 (or any other surface or portion of the current collector and the collar) may be arranged or configured in an overlapping relationship or position, such that the joint therebetween is a lap, edge or similar joint, described in other embodiments. Moreover, the embodiment of FIG. 3 eliminates the need for head members and inner sealing rings of some of the prior art cells.

With continued reference to FIG. 3, the interior aperture 216 of the cathode current collector may be larger (e.g., defines a larger cross-section in the filling direction) than the internal or interior aperture typically provided by the head portion of prior art cells. The larger opening for the current collector can very advantageously provide for faster filling of the cathodic chamber 227 of cells 200, as compared to prior art cells.

For most embodiments of the present invention, current collector 210 (not necessarily drawn to scale) is in the form of a porous metallic mesh. The metal, or metal alloy, usually comprises nickel, e.g., alloys containing at least about 25% by weight nickel. However, the current collector can be formed of other metals or metal alloys in some situations, depending on cell design.

In the case of sodium metal halide cells, the current collector material usually must be one that is non-reactive with any of the halide components in the cell, while still retaining the required electrical conductivity characteristics. Non-limiting examples of current collector materials for some embodiments include molybdenum, tungsten, tungsten carbide, noble metals such as gold, platinum, and iridium; as well as various iron-nickel alloys or nickel-cobalt ferrous alloys, e.g., Kovar®-type materials. One illustrative material of this type may include about 29% (by weight) nickel, 17% cobalt, less than 1% (each) of carbon, silicon, and manganese, with the balance being iron.

The present inventors discovered that the presence of a mesh can very advantageously increase the surface area of the current collector, allowing it to exhibit less electrical resistance, and carry more current. These attributes are especially important in the case of cell designs like that of FIG. 3, which is designed for efficient manufacture, and allows for effective filling of cathode granules in the cathode chamber, e.g., granules of nickel/sodium chloride materials. During operation of the cell, in the charging state, the electrochemical reaction begins at the electrode-electrolyte interface. In this illustration, the interface is formed as the cathode (nickel/NaCl)-separator tube (beta” alumina) boundary. As charging of the cell progresses, the electrochemical “front” moves toward the center of the cathode. Although the inventors do not wish to be bound by any specific theory, it appears that the use of a cylindrical mesh current collector that is relatively close to the separator decreases the distance that electrons must travel during cell operation, which can, in turn, lead to an increase in the power density of the cell.

The size of the mesh can vary to some degree; and will be determined by a number of factors, such as the type and shape of cathode material being used; the particular design and shape of the cathode chamber; and the type of metal forming the mesh. In some embodiments for alkali metal halide cells, the average area of the mesh opening is in the range of about 2 mm to about 4 mm. The mesh can itself have various shapes or “weaves”, e.g., square-like, diamond-shaped, and the like. Preferably, the mesh is formed of an interlaced structure of metallic wire. The size of the wire that forms the mesh can also vary, based on some of the factors set forth above. The wire may have a diameter in the range of about 0.1 mm to about 1 mm, as an example.

As shown in FIG. 3, current collector 210 includes a lower portion 219, generally situated below cap member 217; and an upper portion 223. The upper portion may terminate as flange 225, situated over the top of collar 212. Lower portion 219 is in the shape of the mesh, i.e., characterized by a selected porosity. Upper portion 223, usually above the maximum level for cathode material within the cell, could also be mesh shaped, but is usually a solid material.

As is apparent from the drawings, the cathodic chamber is often tubular, and the mesh is in the form of an elongated cylinder. The cylinder is generally concentric with the tubular cathodic chamber. FIG. 4 is a cross-sectional view of the mesh-like cathode collector, as shown according to planar view 4-4. (However, in alternative embodiments, not shown, the cathode current collector need not define a tube or tube-like structure, but can be in a variety of other shapes, arrangements, or orientation positions.)

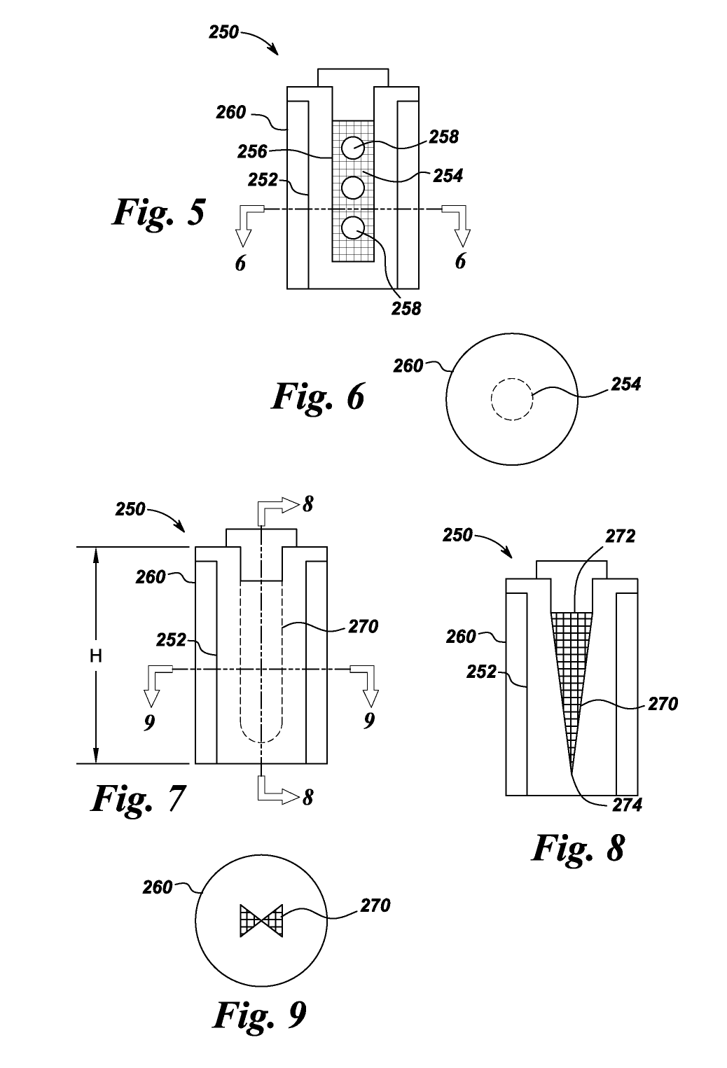

FIG. 5 represents another embodiment of an energy storage cell 250 according to embodiments of the invention, in which a cathode and an anode chamber are separated by electrolyte separator 252. It should be noted that features of the cell which are similar or identical to the cell of FIG. 3 may not be specifically marked, and other features may be omitted for ease-of-viewing, e.g., various braze layers. As in the case of FIG. 3, the current collector 254 is in the form of a porous metallic mesh, e.g., one comprising nickel.

In the embodiment of FIG. 5, the mesh that forms current collector 254 again may be in cylindrical form, i.e., with a cylindrical outer wall 256. FIG. 6 is a simplified top-view of the cell, showing cell case 260 and cylindrical current collector 254. With reference to FIG. 5, a multitude of apertures 258 extend through the wall. The apertures are configured to allow the passage of cathodic material through the current collector wall 256. In this manner, filling of the cathode chamber with the cathode material can occur more quickly.

As those skilled in the art understand, the cathode materials are often in the form of granules, e.g., granules of sodium chloride. Sodium chloride in the cathode dissolves to form sodium ions and chloride ions during charging of the electrochemical cell. Sodium ions, under the influence of applied electrical potential, conduct through the separator 252, and combine with electrons from the external electrical circuit, to form the material of the sodium electrode. Chloride ions react with the cathodic material to form metal chloride, donating electrons back to the external circuit. During discharge, sodium ions conduct back through the separator, reversing the reaction, and generating electrons, as described, for example, in U.S. Pat. No. 8,530,090 (Seshadri et al), incorporated herein by reference.

With continued reference to FIG. 5, the number of apertures 258 can vary to some extent, as can their size, and their arrangement on the surface (wall) 256 of the current collector. Often, the apertures are circular in shape, although other shapes are possible as well. The factors noted above, in reference to the mesh, will be useful here as well, e.g., the size, shape, amount, and type of cathode material being used; and the type of metal forming the mesh. A non-limiting example can be provided for an electrochemical cell having an overall height of about 250 mm to about 275 mm, with a cylindrical current collector having an overall height of about 100 mm to about 250 mm (although this dimension can vary considerably), and a cylindrical diameter in the range of about 1 mm to about 100 mm. This type of current collector may include about 6-24 of the cylindrical holes, each having an area (hole opening) of about 5 mm² to about 40 mm². The apertures should generally be large enough to accommodate the passage of the cathode particles, e.g., granules. Moreover, the overall size and the number of apertures should not be large enough to adversely affect the physical integrity of the mesh.

FIGS. 7 and 8 represent another embodiment of the invention, in which like numerals represent the same features as in FIG. 5. In this instance, mesh current collector 270 can have a triangular profile along the height “H” of the tube. An economic advantage of this embodiment is that the mesh requires less metallic material than in other designs, although it may not be able to transfer as much electrical current in some instances. Thus, the design may be appropriate for energy storage applications in which relatively high power density is not required.

FIG. 8 represents a perspective along plane 8-8 of FIG. 7, and more clearly shows the triangle shape. The general shape can vary to some degree, depending on factors like required mesh strength and current-carrying capacity. The length of base 272 can vary, as can the overall “height” from the base to the apex 274. (One advantage in this instance is that a larger current-carrying region for the structure is available near the top of the cell, where greater electrochemical activity is sometimes expected). FIG. 9 is another (“top”) perspective of the cell, showing an illustrative shape for the triangular current collector 270, resembling a “bow-tie” configuration.

As mentioned previously, the case and the ceramic collar of an energy storage device according to this invention are preferably sealed to each other by at least one active braze. (Other structures within the cell can also be brazed, as described herein). Typically, “brazing” uses a braze material (usually an alloy) having a lower liquidus temperature than the melting points of the components (i.e. their materials) to be joined, e.g., metal components and an alpha-alumina collar. The braze material is brought to or slightly above its melting (or liquidus) temperature, while protected by a suitable atmosphere. The braze material then flows over the components (known as wetting), and is then cooled to join the components together.

As used herein, “braze alloy composition” or “brazing alloy”, or “braze material”, refers to a composition that has the ability to wet the components to be joined, and to seal them. A braze alloy for a particular application should withstand the service conditions required, and melt at a lower temperature than the base materials, or melt at a very specific temperature. Conventional braze alloys usually do not wet ceramic surfaces sufficiently to form a strong bond at the interface of a joint. In addition, the alloys may be prone to sodium and halide corrosion.

As used herein, the term “brazing temperature” refers to a temperature to which a brazing structure is heated to enable a braze alloy to wet the components to be joined, and to form a brazed joint or seal. The brazing temperature is often higher than or equal to the liquidus temperature of the braze alloy. In addition, the brazing temperature should be lower than the temperature at which the components to be joined may not remain chemically, compositionally, and mechanically stable. There may be several other factors that influence the brazing temperature selection, as those skilled in the art understand.

Embodiments of the present invention utilize a braze alloy composition capable of forming a joint by “active brazing” with one or more “active brazes.” In some specific embodiments, e.g., in the case of sodium-based thermal batteries, the braze composition also has a relatively high resistance to sodium and halide corrosion.

In some embodiments, the braze alloy composition includes nickel and an active metal element; and further comprises a) germanium, b) niobium and chromium, or c) silicon and boron. Alternatively, the braze alloy composition may comprise copper, nickel, and an active metal element. Each of the elements of the alloy contributes to at least one property of the overall braze composition, such as liquidus temperature, coefficient of thermal expansion, flowability or wettability of the braze alloy with a ceramic, and corrosion resistance.

“Active brazing” is a brazing approach often used to join a ceramic to a metal or a metal alloy, or a ceramic to a ceramic. Active brazing uses an active metal element that promotes wetting of a ceramic surface, enhancing the capability of providing a seal (e.g., a hermetic seal). “Sealing”, as used herein, is a function performed by a structure that joins other structures together, to reduce or prevent leakage through the joint between the other structures. The seal structure may also be referred to as a “seal.” An “active metal element”, as used herein, refers to a reactive metal that has higher affinity to the oxygen compared to the affinity of element to the ceramic, and thereby reacts with the ceramic.

A braze alloy composition containing an active metal element can also be referred to as an “active braze alloy.” The active metal element is thought to undergo a decomposition reaction with the ceramic, when the braze alloy is in a molten state, and leads to the formation of a thin reaction layer on the interface of the ceramic and the braze alloy. The thin reaction layer allows the braze alloy to wet the ceramic surface, resulting in the formation of a ceramic-metal joint/bond, which may also be referred to as “active braze seal.”

Thus, an active metal element is an essential constituent of a braze alloy for employing active brazing. A variety of suitable active metal elements may be used to form the active braze alloy. The selection of a suitable active metal element mainly depends on the chemical reaction with the ceramic (e.g., alpha-alumina of the collar) to form a uniform and continuous reaction layer, and the capability of the active metal element of forming an alloy with a base alloy (e.g. Ni—Ge alloy).

An “active” element will react with the ceramic, forming a reaction layer between the ceramic and the molten braze that will reduce the interfacial energy to such a level that wetting of the ceramic takes place. In some preferred embodiments, the active metal element is titanium. Other suitable examples of the active metal element include, but are not limited to, zirconium, hafnium, and vanadium. A combination of two or more active metal elements may also be used.

The presence and the amount of the active metal may influence the thickness and the quality of the thin reactive layer, which contributes to the wettability or flowability of the braze alloy, and therefore, the bond strength of the resulting joint. The active metal element is generally present in small amounts suitable for improving the wetting of the ceramic surface, and forming the thin reaction layer, for example, a layer of less than about 10 microns. A high amount of the active metal layer may cause or accelerate halide corrosion.

The braze alloy composition may further include at least one alloying element. The alloying element may provide further adjustments in several required properties of the braze alloy, for example, the coefficient of thermal expansion, liquidus temperature, and brazing temperature. In one embodiment, the alloying element can include, but is not limited to, cobalt, iron, chromium, niobium or a combination thereof.

Several of the exemplary locations for the active braze are shown in FIG. 3. An active braze layer 229 (or braze deposit in some other shape) can be formed between flange 225 and the top surface 231 of ceramic collar 212. An active braze layer 233 can also be formed between the inner surface 235 of cell case 202 and an outer facing surface 237 of the collar. As indicated previously, the use of active braze seals can be especially advantageous, eliminating a number of other sealing mechanism, e.g., multiple weld joints, or bridge-mechanisms. Thus, in some embodiments for a cell like that depicted in FIG. 3, one or more of the various cell structures, e.g., cell case, ceramic collar, cathode/anode chambers, and current collector, can be joined together by one or more “bridgeless seals”. The use of the active braze-sealing mechanism, along with the metallic mesh current collector, can thus provide an electrochemical cell with improved structure and reliability, along with enhanced power density.

Those skilled in the art understand that commercial energy storage devices most often include a plurality of the electrochemical cells described herein. The cells are, directly or indirectly, in thermal and/or electrical communication with each other. Those of ordinary skill in the art are familiar with the general principles of such devices.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

What is claimed:

1) An energy storage cell, comprising:
(a) an anodic chamber for containing an anodic material; and a cathodic chamber for containing a cathodic material, separated from each other by an electrolyte separator tube, all contained within a case for the cell;
(b) an electrically insulating ceramic collar positioned at an opening of the cathodic chamber, and defining an aperture in communication with the opening; and
(c) a current collector brazed to the ceramic collar, extending into the cathodic chamber, and in the form of a porous, metallic mesh;
wherein the case and the ceramic collar are hermetically sealed to each other by at least one active braze.

2) The storage cell of claim 1, wherein the mesh is formed of a material comprising nickel.

3) The storage cell of claim 2, wherein the material of the mesh comprises at least about 25% by weight nickel.

4) The storage cell of claim 1, wherein the average area of the mesh opening is in the range of about 2 mm to about 4 mm.

5) The storage cell of claim 1, wherein the mesh is formed of an interlaced structure of metallic wire.

6) The storage cell of claim 5, wherein the average diameter of the metallic wire is in the range of about 0.1 mm to about 1 mm.

7) The storage cell of claim 1, wherein the cathodic chamber is tubular, and the mesh is in the form of an elongated cylinder that is generally concentric with the tubular cathodic chamber.

8) The storage cell of claim 7, wherein the mesh comprises an outer cylindrical wall; and a multitude of apertures extend through the cylindrical wall.

9) The storage cell of claim 8, wherein the apertures are configured to allow the passage of cathodic material therethrough, during operation or charging of the storage cell.

10) The storage cell of claim 1, wherein the cathodic chamber is tubular, and the mesh is in the shape of a triangle along a height dimension of the tubular cathodic chamber.

11) The storage cell of claim 1, wherein the case and the ceramic collar are sealed to each other by a bridgeless seal.

12) The storage cell of claim 1, wherein the ceramic collar includes a first sealing surface extending round a peripheral region of the collar, and wherein the first sealing surface of the collar is hermetically sealed to at least a second sealing surface of the case by the active braze.

13) The storage cell of claim 12, wherein the anodic chamber is defined by the case, the ceramic collar, and the electrolyte separator tube.

14) The storage cell of claim 13, wherein the separator tube is formed of a beta”-alumina (beta double prime alumina) material; and the ceramic collar comprises alpha-alumina.

15) The storage cell of claim 1, wherein the active braze comprises nickel, an active metal element, and at least one element selected from the group consisting of germanium, copper, niobium, chromium, cobalt, iron, molybdenum, tungsten, and palladium.

16) The storage cell of claim 15, wherein the active braze further comprises at least one of silicon or boron.

17) The storage cell of claim 15, wherein the active metal of the braze comprises titanium, zirconium, hafnium, vanadium, or a combination thereof.

18) The storage cell of claim 15, wherein the active metal of the braze comprises titanium.

19) A sodium metal halide thermal battery, comprising a plurality of electrochemical cells that are in electrical communication with each other, wherein each electrochemical cell comprises:
(a) an anodic chamber for containing an anodic material; and a cathodic chamber for containing a cathodic material, separated from each other by an electrolyte separator tube, all contained within a case for the cell;
(b) an electrically insulating ceramic collar positioned at an opening of the cathodic chamber, and defining an aperture in communication with the opening; and
(c) a current collector brazed to the ceramic collar, extending into the cathodic chamber, and in the form of a porous, metallic mesh;
wherein the case and the ceramic collar are directly, hermetically sealed to each other by at least one active braze.
